(19) United States
(12) Patent Application Publication
(10) Pub. No.: US 2009/0293306 A1
(43) Pub. Date: Dec. 3, 2009

(54) Manufacture of Articles, Such as Footwear

(76) Inventors: Reiner Xaver Sedelmeier, Stuttgart (DE); Heinz Joachim Sedelmeier, London (GB); Mark William Walker, Northampton (GB)

Correspondence Address: CONLEY ROSE, P.C.;David A. Rose, P. O. BOX 3267, HOUSTON, TX, 77253-3267, US

(21) Appl. No.: 11/573,438

(22) PCT Filed: Mar. 7, 2005
(86) PCT No.: PCT/GB05/00853

§ 371 Date: Aug. 3, 2009

(30) Foreign Application Priority Data
Aug. 10, 2004 (DE) 102004038674.9

(51) Int. Cl. A43B 7/14; B32B 3/20; B29D 31/518; B29C 44/34; B29C 45/14; A43B 7/06

(52) U.S. Cl. 36/88; 428/188; 428/221; 264/50; 264/259; 36/3 B; 36/3 A

(57) ABSTRACT

A mat (12) of impervious material for incorporation in an article, such as an article of footwear, for enabling airflow has a plurality of passageways (14) extending in a plane of the mat (12). At least one of the passageways of the plurality (14) is interconnected with at least one further passageway which extends substantially transversely to the plane of the mat (12). Air in passageways of the plurality can therefore flow to the further passageway(s) and air in the further passageway(s) can flow to passageways of the plurality. Air can therefor flow within the mat in two substantially transverse directions. Such a mat can be incorporated into an article to enable air flow into and out of the article.

The present invention relates to a mat of impervious material and to method of making a mat. The invention also relates to a support layer and to a method of making the support layer and to an article, such as footwear, incorporating such a support layer.

It is known to provide holes which extend from inside a shoe, such as a sports shoe, through the sole. The holes are provided to enable air to flow into and out of the shoe for comfort and ventilation. Where holes are provided on the bottom of a shoe, they may easily become blocked.

It has also been known to provide tubes within the sole of a shoe. This is known from patent number DE 19520374. The tubes form passages through the sole and are formed with holes that provide a connection of air between outside surroundings and the inside of the footwear. Construction of this type of sole, however, is very difficult, as all of the tubes have to be aligned with one another prior to the sole being formed so that a carrier layer can be applied to join the tubes together. This makes manufacturing of these soles very expensive and time consuming.

The present invention seeks to overcome some of the above-identified problems.

According to a first aspect of the present invention, there is provided a mat of impervious material for incorporation in an article for enabling airflow, the mat comprising a plurality of passageways extending in a plane of the mat, at least one of the passageways of the plurality being interconnected with at least one further passageway which extends substantially transversely to the plane of the mat, whereby air in passageways of the plurality can flow to the further passageway(s) and air in the further passageway(s) can flow to passageways of the plurality.

A mat of embodiments of the invention has interconnected passageways which enable air to flow within the mat in two substantially transverse directions. Such a mat can be incorporated into an article to enable air flow into and out of the article.

In an embodiment, the plurality of passageways are defined by a series of hollow tubes extending generally in the plane of the mat, and the further passageway(s) are defined by hollow tubes which extend generally in a direction substantially transverse to the plane of the mat, and the plurality of passageways are interconnected to the further passageway(s) at points at which passageways of the plurality intersect with further passageways.

Preferably, each passageway of the plurality will interconnect with one or more further passageways. Generally, therefore, the number of further passageways provided will determine the number of intersections within the mat. It will be apparent that if more points of intersection are provided between each passageway of the plurality and the further passageways, the amount of air flow within the mat can be increased.

Preferably, hollow tubes defining at least some of the plurality of passageways extend substantially parallel to one another, and hollow tubes defining at least some of the further passageways extend substantially parallel to one another.

The provision of hollow tubes which extend parallel to one another facilitates the manufacture of the mat. However, it will be appreciated that provided air can flow between the plurality of passageways to the further passageways and vice versa, any configuration of hollow tubes may be used.

The hollow tubes forming the passageways may be of any cross-section, for example oval, triangular, elliptical, square or rectangular. However, in a preferred embodiment, the hollow tubes are of circular cross-section.

The plurality of passageways may extend through the plane of the mat in any known manner, for example, the passageways may be curved or formed in the shape of chevrons. In a preferred embodiment, the passageways of the plurality extend from one side of the mat to the other substantially linearly.

Preferably, the mat is integrally formed of a single piece of material.

Advantageously, this strengthens the structure of the mat and results in a mat that is easier to manufacture and to incorporate in an article.

The mat may be formed of any impervious material which has a degree of elasticity and which can be formed to the required structure. Preferably, the mat is formed from a thermoformable material, for example, a thermoplastic material.

In a preferred embodiment, the mat is formed of a thermoplastic polymeric material.

The mat may be made in any suitable manner. For example, the mat may be formed by thermoforming. In an embodiment, the mat is made by moulding, for example, by extrusion moulding.

In a preferred embodiment, at least one opening is provided in a side of the mat in communication with the passageways of the plurality to enable air to flow into and out of the mat.

Typically, the openings in the side of the mat have been formed by cutting across the passageways of said plurality.

In a preferred embodiment, at least one opening is provided in a top surface of the mat in communication with the further passageways such that air can flow between the openings in the side of the mat and the openings in the top surface of the mat by way of further passageways and the passageways of the plurality.

Any known method may be used to form openings in the top surface of the mat, for example, the tops of the further passageways could be cut off.

In a preferred embodiment, the openings in the top surface of the mat have been formed by scouring the top surface of the mat to form holes communicating with the further passageways.

The mat may be incorporated into any article where increased comfort and ventilation may be required. The mat may be cut into any shape or size according to its intended use. The mat may be incorporated in articles, for example, in a sun or yoga bed, or for extra cushioning and ventilation in a car or baby seat. Alternatively the mat may be incorporated in a rucksack where the openings in the top surface of the mat are located adjacent a persons back when in use. In an article of this sort, as well as the additional comfort of the mat the person is also provided with adequate ventilation. Preferably, the mat is incorporated into an article of footwear.

More preferably, the mat has been cut into the shape of a sole for use as part of a shoe.

The present invention also extends to a support layer for enabling airflow between an upper surface and a side thereof, the support layer comprising a plurality of passageways extending in a plane of the support and in communication with openings in the side of the support layer, at least one of the passageways of the plurality being interconnected with at least one further passageway which extends substantially transversely to the plane of the support layer and is in communication with at least one opening in an upper surface of the support layer, whereby air can flow between openings in the upper surface of the support layer and openings in the side thereof.

A support layer of embodiments of the invention has interconnected passageways that enable air to flow in two substantially transverse directions between openings located in a side of the support layer and an upper surface of the support layer.

Preferably, the passageways of the plurality and the further passageways are defined within a mat as defined above.

In an embodiment, the support layer further comprises a layer of polymeric material provided on a top surface of the mat, wherein the further passageway(s) extend through the layer of polymeric material and are in communication with corresponding opening(s) in the upper surface of the support layer.

When the polymeric layer has been applied, the support layer may be shaped to suit any of the above described uses. Moreover, the polymeric layer provides a flat upper surface to the support layer, making its use more versatile when incorporated in an article as the flat surface is more suitable for adhering to other surfaces

Preferably, the support layer further comprises a layer of polymeric material provided on a bottom surface of the mat to form a layered structure.

Preferably, the support layer has been formed into the shape of a sole of a shoe and forms part of a shoe.

In one embodiment, the support layer forms part of a sole of the shoe.

In an alternative embodiment, the support layer forms a sole of the shoe.

In a further embodiment, the support layer is inserted into one or more recesses formed in a sole of a shoe.

The present invention also extends to a method of making a mat of impervious material for incorporation into an article to enable airflow therein, the method comprising charging impervious material into a mould cavity which defines the structure of a mat; and expanding the impervious material within the mould cavity to form a sealed mat structure whose shape is determined by the shape of the mould cavity, expansion of the impervious material being by injecting fluid therein such that hollow passageways are formed within the resultant mat.

As fluid is injected into the impervious material in the mould, the material expands to fit the mould cavity such that a sealed mat structure is formed and hollow passageways are formed within the resultant mat. In a preferred embodiment, the fluid injected into the material is air.

Preferably, a plurality of grooves are provided in the mould cavity for defining in the resultant mat a plurality of passageways which extend in a plane of the mat, and wherein at lest one indentation is provided along one of said plurality of grooves for defining in the resultant mat a further passageway which extends substantially transverse to the plane of the mat.

Thus, interconnected passageways are formed within the mat which enable air to flow within the mat in two substantially transverse directions.

The present invention also extends to a method of making a support layer incorporating a mat as defined above, the method comprising forming a support layer by forming a layer of a polymeric material on a top surface of the mat; cutting the support layer into a desired shape to form openings at a side of the support layer which communicate with the mat, and forming at least one opening communicating with the mat in an upper surface of the support layer.

Before the support layer is cut into a desired shape, a layered structure is formed of a layer of polymeric material and the sealed mat. When the support layer is cut into shape, the passageways of the plurality that extend in the plane of the mat are also cut across to form openings at the side of the support layer which communicate with the mat. Similarly, openings are provided on the upper surface of the support layer which communicate with the mat such that air is able to flow between a side of the support layer and the upper surface thereof.

In an embodiment, the method further comprises layering a bottom surface of the mat with a layer of polymeric material to form a support layer having layers of polymeric material on each of a top and bottom surface of the mat.

The support layer may be formed by any known method where polymeric material may be layered on either side of a sealed mat. In a preferred embodiment, the method comprises moulding the polymeric layers around the mat to form the support layer.

The present invention also extends to an article incorporating a support layer as defined above, the support layer being arranged to enable air to flow through at least part of the article.

The present invention also extends to an article of footwear comprising an upper part; and a sole part incorporating a support layer as defined above, wherein an upper surface of the support layer is proximate a base of the upper part such that air can flow from within the support layer to within the upper part.

The incorporation of the support layer in the sole of the footwear provides a user with additional comfort and ventilation as air is able to circulate between the footwear and the external surroundings.

Preferably, the support layer is located between a sole of the footwear and the upper part.

Alternatively, the support layer forms a sole of the footwear.

In this embodiment, the support layer can be shaped to form any desired shape of sole. Advantageously, where the support layer forms the sole, one less step would be required in forming the footwear.

In a further alternative embodiment, the support layer is inserted into one or more recesses formed in a sole of the footwear.

In this embodiment, the support layer can not be seen. This may be preferable when the support layer is to be incorporated in more formal footwear, for example, work shoes.

In a preferred embodiment, the article of footwear further comprises a water proof membrane, pervious to air, which is located between the upper surface of the support layer and the interior of the upper part.

The provision of this membrane prevents water from entering the footwear, but still allows flow of air into and out of the footwear.

In an embodiment, the membrane forms a base of the upper part of the footwear.

The membrane may be formed of any known water-proof breathable membrane, for example Gortex™.

Preferably, the membrane is formed of polytetrafluoro ethylene.

According to the present invention, a mat made out of a flexible material is provided for use as part of a sole or inner sock for footwear. The mat has several hollow spaces formed by tubes running sideways through the mat, the tubes being provided with a connection to an inside of the footwear.

The present invention also extends to a method of producing a flexible mat having tubes and chimneys forming hollow spaces interconnected with each other. The normally open ends of the flexible mat being closed when made in a mould.

Embodiments of the present invention will hereinafter be described, by way of example, with reference to the accompanying drawings, in which:

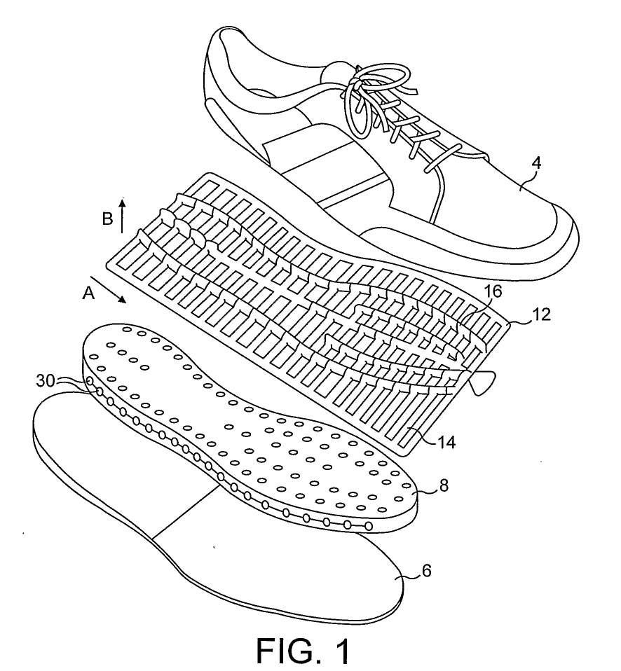

FIG. 1 shows an exploded illustration of a shoe incorporating a mat of the present invention, including a perspective view of the mat;

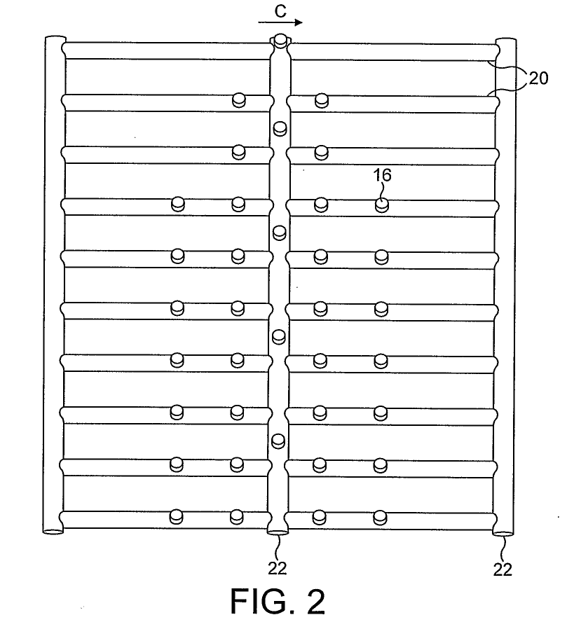

FIG. 2 shows an enlarged view of part of a mat as shown in FIG. 1;

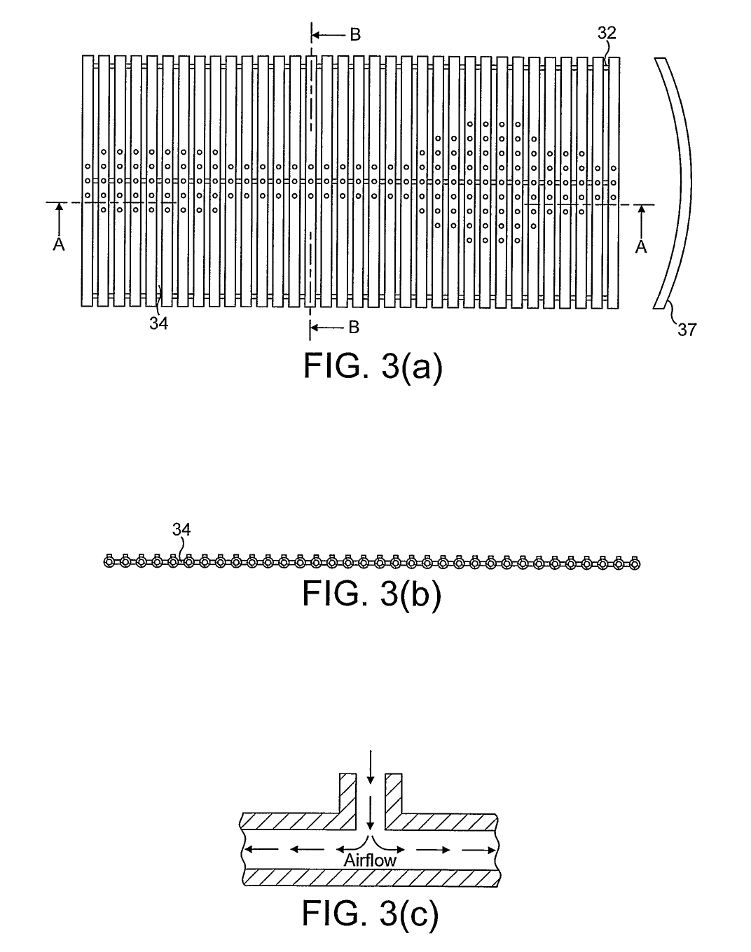

FIG. 3(a) shows a plan view from above of a mat of the invention,

FIG. 3(b) shows a cross-section taken through line A-A FIG. 3(a), and

FIG. 3(c) shows schematically, and on an enlarged scale, a cross-section of a passageway within the mat taken along line B-B of FIG. 3(a);

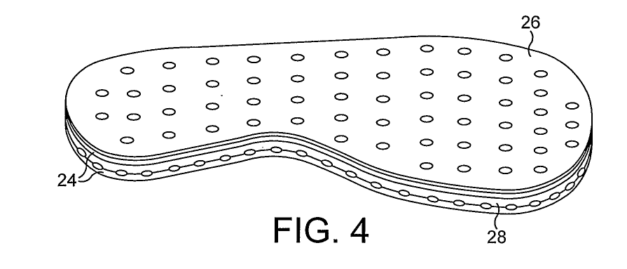

FIG. 4 shows a perspective view of a support layer of the present invention, incorporating a mat as shown in FIG. 1;

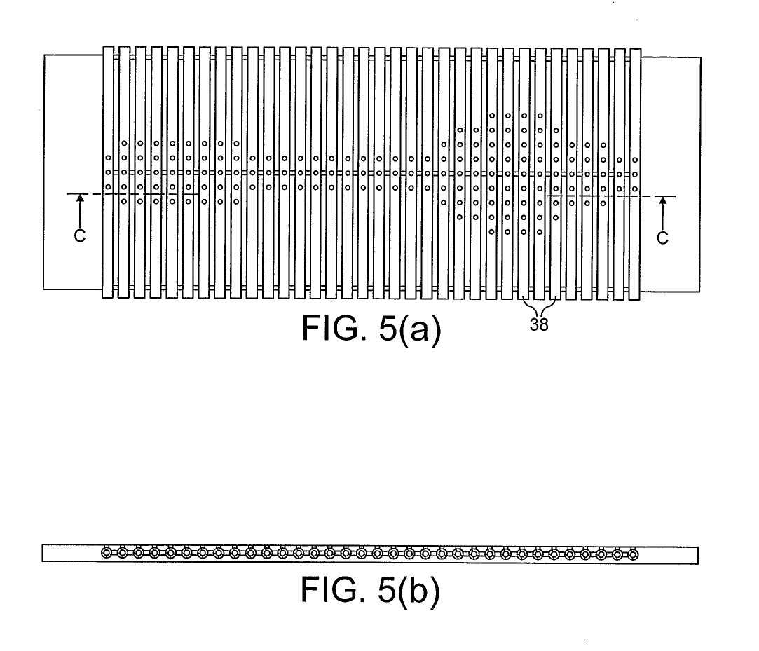

FIG. 5(a) shows a plan view from above of a support layer of the invention, incorporating a mat as shown in FIGS. 3(a) to 3(c), and

FIG. 5(b) shows a cross-section taken along line C-C of FIG. 5(a);

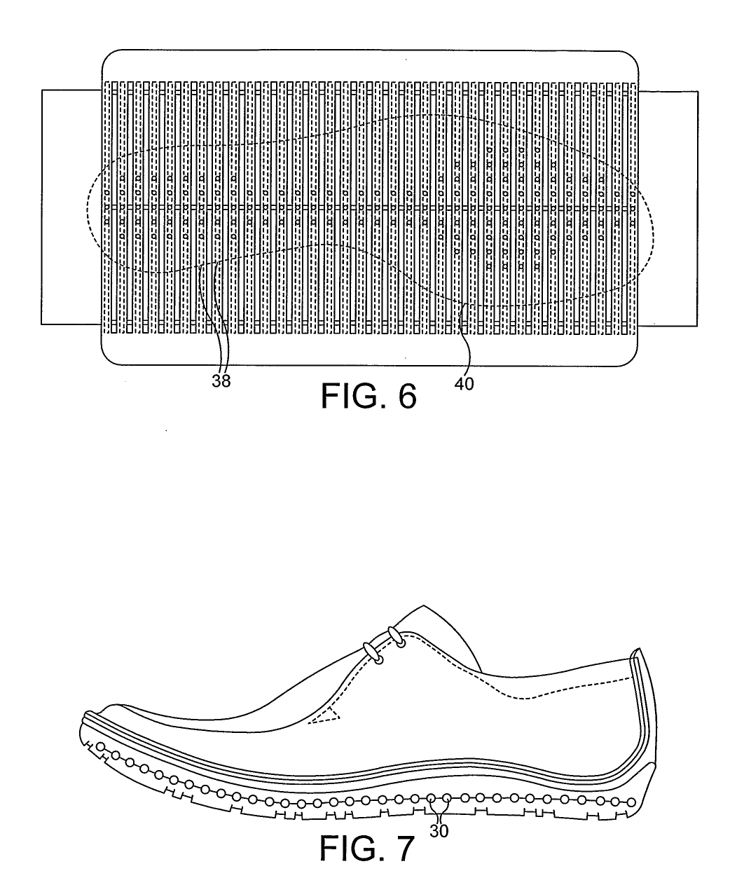

FIG. 6 shows a plan view of the support layer of FIG. 5(a) indicating an area to be cut-out;

FIG. 7 shows a side view of a shoe of the present invention, incorporating a support layer as shown in FIG. 4;

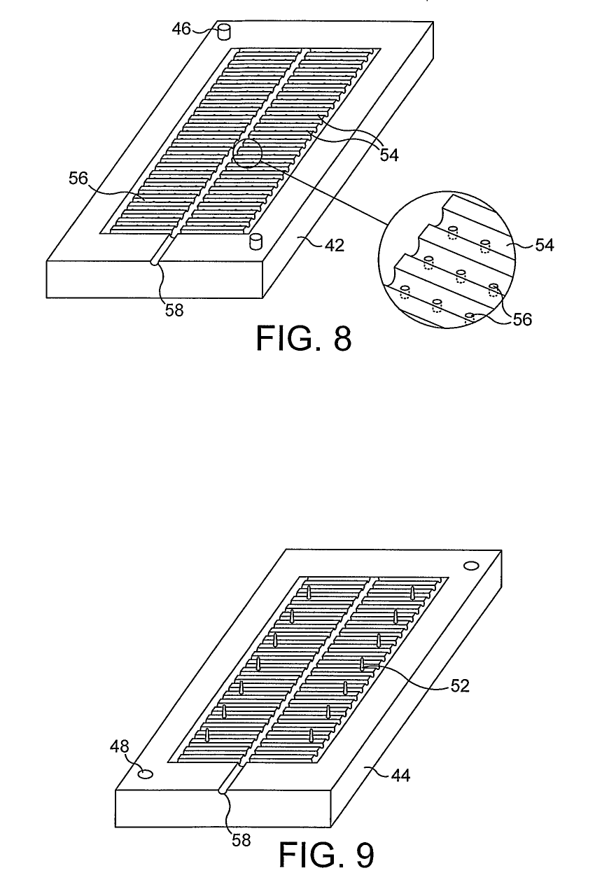

FIG. 8 shows a perspective view of one half of a mould for use in forming a mat of the invention;

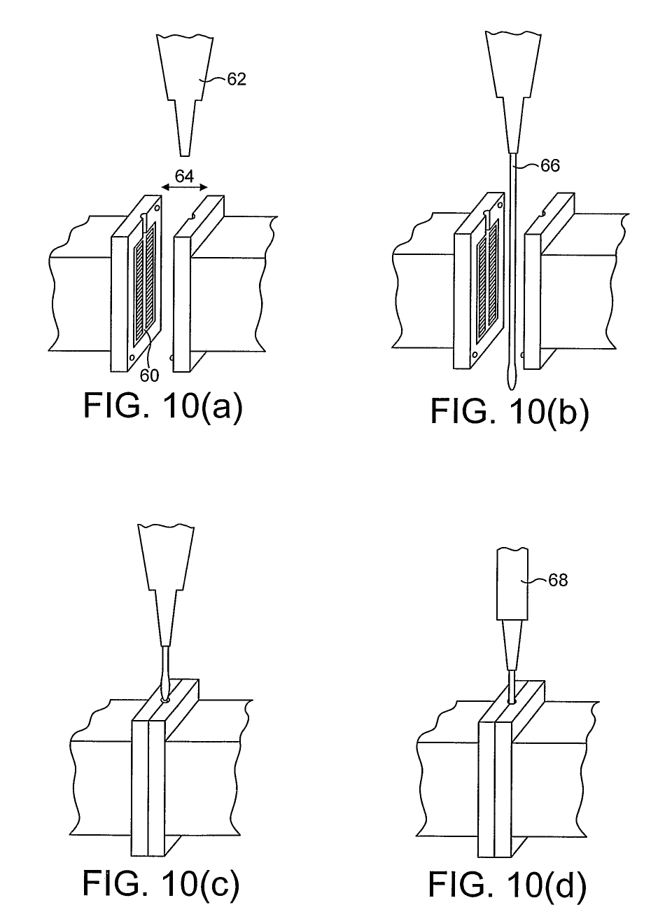

FIG. 9 shows a perspective view of a second half of a mould for use in forming a mat of the present invention;

FIGS. 10(a) to 10(d) show schematically the steps of a method for moulding a mat of the invention;

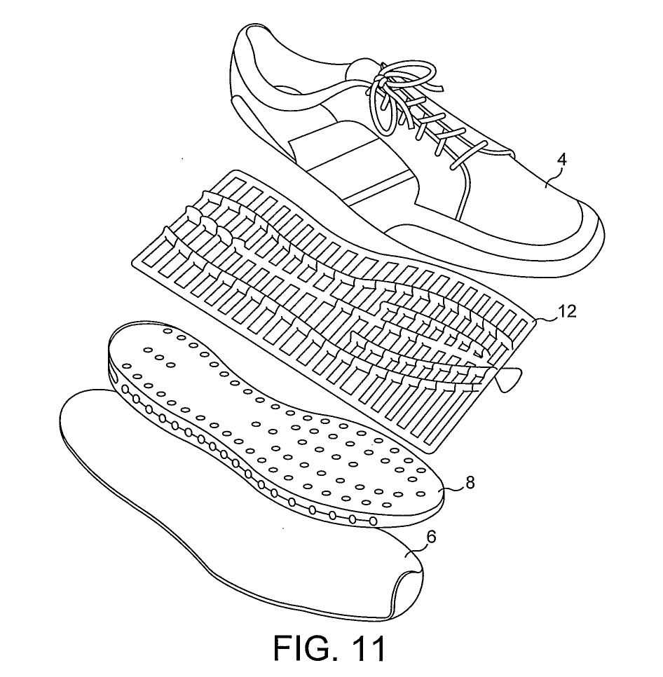

FIG. 11 shows an exploded illustration of an alternative embodiment of a shoe in which a support layer forms part of a sole of the shoe, including a perspective view of the mat;

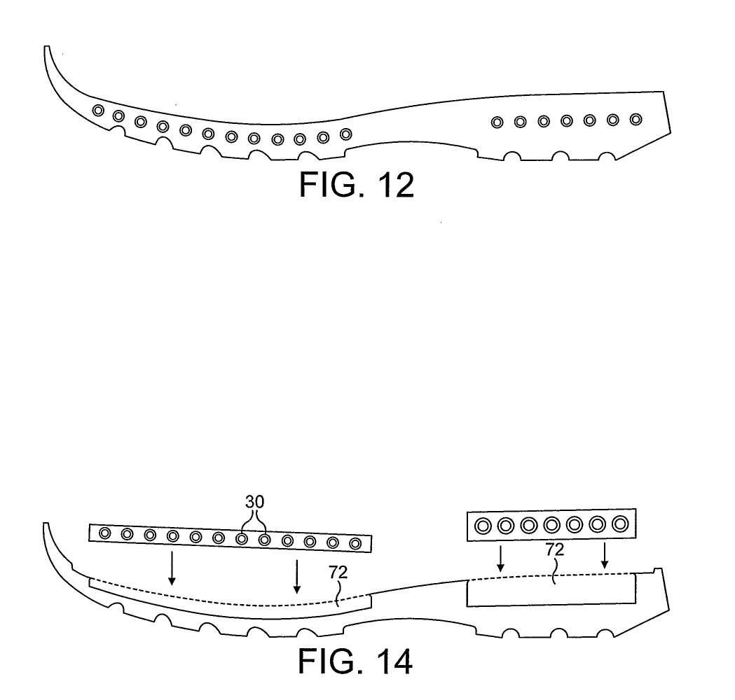

FIG. 12 shows a side profile of the sole of the shoe of FIG. 11;

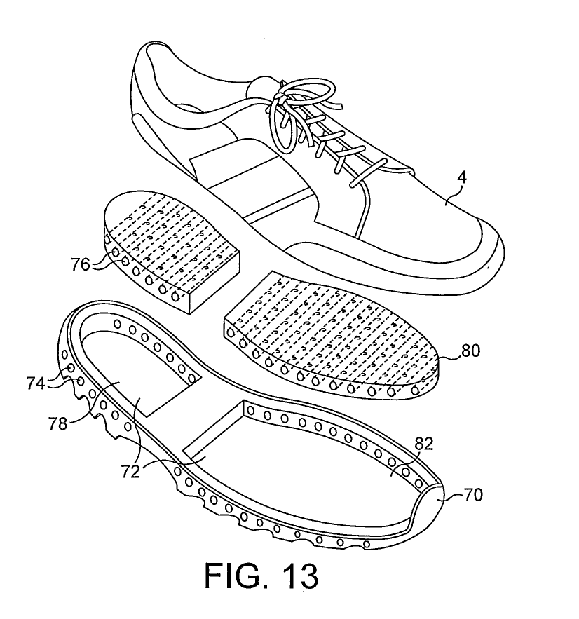

FIG. 13 shows an exploded illustration of a further embodiment of a shoe in which a support layer is located in recesses formed in a sole of the shoe, including a perspective view of the mat;

FIG. 14 shows a side profile of the sole of the shoe of FIG. 13;

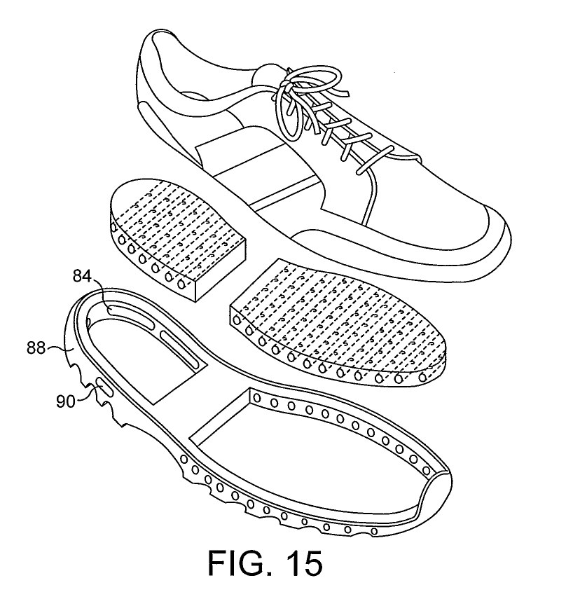

FIG. 15 shows an exploded view of an alternative embodiment of a shoe in which a support layer is located in recesses in a sole.

The present invention is concerned with providing air to the inside of an article to provide additional comfort and some ventilation. The mats, support layers and other structures described herein may be incorporated into any articles, for example, in a sun or yoga bed, or as cushioning for a car or baby seat. Alternatively, the mats, support layers and other structures may be incorporated in an article such as a rucksack.

For simplicity, the invention is described herein with reference to footwear, but is not limited to use in footwear. Reference to footwear incorporates reference to all types of footwear, for example, sports shoes, boots and slippers. In the specification, the term “shoe” will be used to refer to all types of footwear.

FIG. 1 shows an exploded view of a shoe incorporating a mat 12 of the present invention. FIG. 1 also shows a perspective view of the mat 12. In the embodiment shown in FIG. 1, the shoe 2 is formed of an upper part 4, a sole 6 and a support layer 8 located between the upper part 4 and the sole 6. The mat 12 is located within the support layer 8.

The sole 6 and support layer 8, incorporating the mat 12, collectively form a sole part of the shoe.

The mat is formed of a plurality of interconnected passageways 14 extending in a plane A of the mat. Further passageways extend from passageways of the plurality in a direction B substantially transverse to the plane of the mat. The further passageways will hereinafter be referred to as “chimneys” 16. This interconnected structure defines a hollow path within the mat through which air can flow in at least two substantially transverse directions.

The passageways 14 are defined by a series of hollow tubes 20 that extend generally in the plane A of the mat. Similarly, the chimneys 16 are defined by hollow tubes that extend generally in a direction substantially transverse to the mat. The passageways 14 are interconnected to the chimneys 16 at each respective point of intersection between the two.

The number of chimneys 16 provided will determine the eventual number of intersections with the mat. It will be appreciated that the number of chimneys provided and their locations may vary depending on the intended use of the mat. It will be apparent that as more points of intersection are provided between the chimneys and the passageways, the amount of air flow with the mat can be increased.

In the embodiment of the mat 12 shown in FIG. 2, the hollow tubes 20 extend parallel to one another. It will be appreciated that provided air can flow between the passageways 14 and the chimneys 16, any configuration of hollow tubes may be used. Specifically, different sections of tubes within the mat may extend in different general directions to enable the mat to be flexed in different directions according to its intended use.

Openings 30 are provided in a side of the mat in communication with the passageways 14 to enable air to flow into and out of the mat. Typically, these openings 30 are formed by cutting across the passageways 14.

Similarly, openings are provided in a top surface of the mat to form holes in communication with the chimneys 16. In the specific embodiment described herein, these openings are formed by scouring the top surface of the mat to form the holes. However, it will be appreciated that any known method may be used to achieve the same effect, for example, the tops of each chimney could be cut off.

FIGS. 3(a), 3(b) and 3(c) show different views of an embodiment of a mat 12 of the invention. In the embodiment shown in FIG. 3(a), the passageways 14 of the mat 12 are interconnected through their centre by an additional passageway running along the length of the mat 12. In the embodiment shown in FIG. 3(a), interconnecting rods 32 are provided that link the hollow tubes together but that do not form part of the hollow structure. It will be appreciated that in some embodiments of the mat 12, the areas between the tubes and interconnecting rods may be left open. In a preferred embodiment, however, (as best seen in FIG. 3(b)), a thin layer of the material 34 from which the mat is made may be found between each of the rods and tubes to strengthen the structure. In this embodiment, the mat is integrally formed of a single piece of material. This results in a mat that is easier to manufacture and to therefore incorporate in an article.

The passageways 14 of the embodiment shown in FIG. 3(a) are shown to be parallel, and extend linearly from one side of the mat to the other. It will be appreciated, however, that the passageways 14 may extend through the mat in any known manner, for example, the passageways may be curved 37, or they may be formed in the shape of parallel chevrons.

FIG. 3(c) shows schematically a path of air within the mat from an opening in the side of the mat through to an opening in one of the chimneys. The cross-section of the hollow tubes shown in FIG. 3(b) are all circular. However, it will be appreciated that the tubes may be of any known cross-section, for example oval, triangular, elliptical, square or rectangular.

The mat may be made of any known impervious material which has a degree of elasticity and which can be formed into the shape of the required mat 12. For example, the mat may be formed of any thermoformable material such as thermoplastic. In the specific embodiment described herein, the mat is formed of a thermoplastic polymeric material.

FIG. 4 shows a perspective view of the support layer 8 of the present invention, incorporating a mat 12 as shown in FIG. 1 and described above. In embodiments of the invention, the support layer is formed with a layer of polymeric material 24 provided on either side of the mat 12 such that openings in communication with the mat 12 are provided on a side 28 of the support layer. In the embodiment shown in FIG. 4, the chimneys 16 of the mat extend through the top layer of polymeric material making the support layer and are in communication with corresponding openings provided in the upper surface 26 of the support layer. Thus, a path of air through the support layer is defined within the mat 12 through which air can flow between the side 28 of the support layer and the upper surface 26 thereof.

FIG. 5(a) shows a plan view from above of a support layer in the process of being formed, incorporating a sealed mat 12. As can be seen in FIG. 5(a), the initial layered structure that subsequently forms the support layer may be formed in any shape. The layered structure may then be cut down to the appropriate size to form the support layer 8.

When forming the support layer 8, the layers of polymeric material 24 are moulded around the mat while the mat is still sealed. This can be seen in FIG. 5(a), where the ends 38 of the passageways of the mat are closed. A cross-section taken along ling C-C is shown in FIG. 5(b) and from this it can be seen that at this stage in the process of forming the support layer, the chimneys 16 are also closed.

FIG. 6 shows a plan view of the structure of FIG. 5(a), indicating an area 40 to be cut out to form the resultant support layer 8. It will be appreciated that when the support layer is cut to the appropriate shape as indicated in FIG. 6, the passageways 14 extending in the plane of the mat will be cut across providing openings 30 to the mat in the side 24 of the support layer and in communication with the passageways 14.

FIG. 7 shows a side view of an embodiment of a shoe. When the shoe is formed, the support layer 8 forms part of the sole of the shoe such that the openings 30 to the mat that are located on the side of the support layer 8 are also located on an outer edge of the shoe 2. The openings in communication with the chimneys 16 of the mat 12 (not shown in FIG. 7) that are located at the upper surface 26 of the support layer 8 are in contact with a base of the upper part 4 of the shoe 2.

Thus, air can flow between an inside of the upper part 4 of the shoe and the side of the shoe, therefore ensuring that adequate ventilation is provided inside the shoe.

A method of preparing the mat and support layer will now be described.

A mould having a top section 42, shown in FIG. 8, and a bottom complimentary section 44, shown in FIG. 9 forms a mould cavity when put together that defines the structure of the mat 12. The top half of the mould 42 is provided with mould location pins 46 for engaging with mould location holes 48 located on the bottom half 44 of the mould. Additional locating holes 50 and locating pins 52 are provided respectively in the body of the top 42 and bottom 44 sections of the mould. These respective pins and holes ensure that the mould is properly positioned when the two mould-haves are brought together.

Each of the top and bottom halves of the mould are provided with corresponding grooves 54, for defining in the resultant mat a plurality of passageways 14 which extend in the plane of the mat. The top half 42 of the mould is further provided with small indentations 56 along the grooves 54 for forming further passageways, chimneys 16, that extend substantially transverse to the plane of the mat. In addition, both mould-halves are provided with a corresponding groove 58 at one end of the mould, such that when the mould-halves are put together, a channel is formed through which air may be injected into the body 60 of the mould.

In use, and as illustrated in FIGS. 10(a) to 10(d), the two halves of the mould are positioned apart from each other with the respective bodies of the top half and bottom half of the mould facing each other, and the channels 58 for injection of air located at the same end. An extrusion machine 62 is positioned above the gap 64 between the two mould-halves. A thermoplastic polymeric material 66 is then charged into the mould cavity. Once a sufficient amount of thermoplastic polymeric material 66 has been charged into the cavity, the mould-halves are brought together, such that the thermoplastic polymeric material is sandwiched between, as shown in FIG. 10(c).

When the two mould-halves have been brought together and placed under pressure, any excess thermoplastic material left outside the mould is removed. The extrusion machine 62 is replaced with a high-pressure air machine 68 and air is injected at controlled pressure into the channel 58 formed between the two mould-halves. As air is injected into the mould, the thermoplastic polymeric material expands within the mould cavity to fill all the grooves 54 and indentations 56 to form a sealed mat structure whose shape is determined by the shape of the mould cavity. The mould is then released, and the resulting sealed mat is placed in a cooling machine for a controlled period to avoid distortion of the bag while cooling. The resultant mat has hollow passageways formed therein.

It should be noted that the mat is airtight at this stage and no openings to the passageways have yet been formed.

The mat 12 is then transferred to a further mould (not shown) where it is held in place between two halves of the mould by location pins. A polymeric material, for example, polyurethane, is injected into the mould to surround the mat 12 to form the layered structure shown in FIG. 5(a). Once this material has set, the resultant layered structure is removed from the mould and cut to size to form the support layer. It will be appreciated that any known material for making shoes may be used to form the support layer. The choice of such material would depend on the intended function of the shoe.

During the second moulding process, it will be appreciated that as the mat is sealed, there is no opportunity for any of the polymeric material to enter the mat. However, once the support layer 8 has been cut to size, as indicated in FIG. 6, the closed ends of the passageways will have been cut away to provide openings at the side 24 of the support layer 8.

Once the support layer has been cut to size, a scouring machine (not shown) is used to scour the top surface of the support layer to form openings to the mat in communication with the chimneys, to enable circulation of air throughout the support layer.

The support layer may be formed of uniform cross-section throughout its length, as shown in FIGS. 1 and 4, or it may be moulded into a shape specific to a particular type of shoe. For example, FIGS. 11 and 12 show an embodiment of the support layer having a deeper, back section. Alternatively, the support layer may be made into several pieces for insertion into the sole of a shoe.

FIG. 13 to 15 show embodiments of a shoe 2 where recesses 72 have been formed in the sole 70. In the embodiment shown in FIGS. 13 and 14, each respective side of the sole has been provided with air vents 74 arranged to coincide with the openings 30 of the mat provided in the side of the support layer. The support layer is formed or cut into two pieces, a first 76 to be placed in the heel portion 78 of the shoe, and a second 80 to be placed in a recess 72 in the front part 82 of the shoe. In this embodiment, the air vents 74 in the sole act as an extension of the passageways of the mat 12 inside the support layer, and the air can flow directly between the outside of the shoe and the mat 12 through the air vents.

In the embodiment shown in FIG. 15, a channel 84 is built into the recess 86 in the heel portion 88 of the shoe. The channel 84 is provided with an air vent 90, such that air leaving the support layer is directed into the channel 84, and exits the shoe through the air vent 90. It will be appreciated that any number of air vents could be provided in the side of the sole to enable airflow of this sort.

In the embodiments shown in FIGS. 13 to 15, the support layer is not visible from the outside of the shoe.

In each of the embodiments shown in FIGS. 1, 4, 11, 13 and 15, a waterproof membrane that is pervious to air (not shown) is provided between the top surface of the mat and the interior of the shoe. This membrane can be situated directly above the support layer, may form the base of the shoe, or may be provided as an insole inside the shoe. The aim of the membrane is to enable air to flow freely in and out of the shoe, but to prevent water from entering the shoe through the mat.

The membrane may be made from any known water-proof breathable material, for example poly-tetrafluoride ethylene, or Gortex™.

It will be appreciated that modifications of, and alterations to, the embodiments as describe and illustrated may be made within the scope of this application.

What is claimed is:

1. A mat of impervious material for incorporation in an article for enabling airflow, the mat comprising a plurality of passageways extending in a plane of the mat, at least one of the passageways of the plurality being interconnected with at least one further passageway which extends substantially transversely to the plane of the mat, whereby air in passageways of the plurality can flow to the further passageway(s) and air in the further passageway(s) can flow to passageways of the plurality

2. A mat as claimed in claim 1, wherein the plurality of passageways are defined by a series of hollow tubes extending generally in the plane of the mat, and the further passageway(s) are defined by hollow tubes which extend generally in a direction substantially transverse to the plane of the mat, and the plurality of passageways are interconnected to the further passageway(s) at points at which passageways of the plurality intersect with further passageways.

3. A mat as claimed in claim 2, wherein hollow tubes defining at least some of the plurality of passageways extend substantially parallel to one another, and hollow tubes defining at least some of the further passageways extend substantially parallel to one another.

4. A mat as claimed in claim 2, wherein the hollow tubes are of circular cross-section.

5. A mat as claimed in claim 1, wherein the passageways of the plurality extend from one side of the mat to the other substantially linearly.

6. A mat as claimed in claim 1, wherein the mat is integrally formed of a single piece of material.

7. A mat as claimed in claim 1, wherein the mat is formed of a thermoplastic polymeric material.

8. A mat as claimed in claim 1, wherein the mat is formed by extrusion moulding.

9. A mat as claimed in claim 1, wherein at least one opening is provided in a side of the mat in communication with the passageways of the plurality to enable air to flow into and out of the mat.

10. A mat as claimed in claim 9, wherein openings in the side of the mat have been formed by cutting across passageways of the plurality.

11. A mat as claimed in claim 9, wherein at least one opening is provided in a top surface of the mat in communication with the further passageways such that air can flow between the openings in the side of the mat and the openings in the top surface of the mat by way of the further passageways and the passageways of the plurality.

12. A mat as claimed in claim 11, wherein openings in the top surface of the mat have been formed by scouring the top surface of the mat to form holes communicating with the further passageways.

13. A mat as claimed in claim 1, wherein the mat has been cut into the shape of a sole for use as part of a shoe.

14. A support layer for enabling airflow between an upper surface and a side thereof, the support layer comprising a plurality of passageways extending in a plane of the support layer and in communication with openings in the side of the support layer, at least one of the passageways of the plurality being interconnected with at least one further passageway which extends substantially transversely to the plane of the support layer and is in communication with at least one opening in an upper surface of the support layer, whereby air can flow between openings in the upper surface of the support layer and openings in the side thereof.

15. A support layer as claimed in claim 14, wherein the passageways of the plurality and the at least one further passageway extend within a mat as claimed in claim 1.

16. A support layer as claimed in claim 14, further comprising a layer of polymeric material provided on a top surface of the mat, wherein the further passageway(s) extend through the layer of polymeric material and are in communication with corresponding opening(s) in the upper surface of the support layer.

17. A support layer as claimed in claim 16, further comprising a further layer of polymeric material provided on a bottom surface of the mat.

18. A support layer as claimed in claim 14, wherein the support layer has been formed into the shape of a sole of a shoe.

19. A support layer as claimed in claim 18, wherein the support layer forms part of a sole of a shoe.

20. A support layer as claimed in claim 18, wherein the support layer forms a sole of a shoe.

21. A support layer as claimed in claim 18, wherein the support layer is inserted into one or more recesses formed in a sole of a shoe.

22. A method of making a mat of impervious material for incorporation into an article to enable airflow therein, the method comprising:
charging impervious material into a mould cavity which defines the structure of a mat; and
expanding the impervious material within the mould cavity to form a sealed mat structure whose shape is determined by the shape of the mould cavity, expansion of the impervious material being by injecting fluid therein such that hollow passageways are formed within the resultant mat.

23. A method as claimed in claim 22, wherein a plurality of grooves ate provided in the mould cavity for defining in the resultant mat a plurality of passageways which extend in a plane of the mat, and wherein at least one indentation is provided along one of said plurality of grooves for defining in the resultant mat a further passageway which extends substantially transverse to the plane of the mat.

24. A method of making a support layer incorporating a mat as claimed in claim 1, the method comprising:
forming a support layer by forming a layer of a polymeric material on a top surface of the mat;
cutting the support layer into a desired shape to form openings at a side of the support layer which communicate with the mat, and
forming at least one opening communicating with the mat in an upper surface of the support layer.

25. A method as claimed in claim 24, further comprising layering a bottom surface of the mat with a layer of polymeric material to form a support layer having layers of polymeric material on each of a top and bottom surface of the mat.

26. A method as claimed in claim 25, farther comprising moulding the polymeric layers around the mat to form the support layer.

27. An article incorporating a support layer as claimed in claim 14, the support layer being arranged to enable air to flow through at least part of the article.

28. An article of footwear comprising;
an upper part; and
a sole part incorporating a support layer as claimed in claim 14, wherein an upper surface of the support layer is proximate a base of the upper part such that air can flow from within the support layer to within the upper part.

29. An article of footwear as claimed in claim 28, wherein the support layer is located between a sole of the footwear and the upper part.

30. An article of footwear as claimed in claim 28, wherein the support layer forms a sole of the footwear.

31. An article of footwear as claimed in claim 28, wherein the support layer is inserted into one or more recesses formed in a sole of the footwear.

32. An article of footwear as claimed in claim 28, further comprising a water proof membrane, pervious to air, which is located between the upper surface of the support layer and the interior of the upper part.

33. An article of footwear as claimed in claim 32, wherein the membrane forms a base of the upper part of the footwear.

34. An article of footwear as claimed in claim 31, wherein the membrane is formed of polytetrafluoro ethylene.
